(19) United States
(12) Patent Application Publication
(10) Pub. No.: US 2005/0081993 A1
(43) Pub. Date: Apr. 21, 2005

(54) Method of bonding glass

(76) Inventors: Steven J, Ilkka, Stillwater, MN (US); James J. Kobe, Newport, MN (US); Shaun D. McCracken, Cottage Grove, MN (US); Ronald H. Meyer, Woodbury, MN (US)

Correspondence Address: 3M INNOVATIVE PROPERTIES COMPANY, PO BOX 33427, ST. PAUL, MN, 55133-3427, US

(21) Appl. No.: 10/687,027

(22) Filed: Oct. 16, 2003

(51) Int. Cl. B32B 31/00

(52) U.S. Cl. 156/309.3; 156/307.3; 156/307.5; 156/307.7; 156/308.2; 156/329

(57) ABSTRACT

The invention provides methods of bonding glass using a tape that comprises an acrylic pressure-sensitive adhesive polymer. Embodiments provide the further steps of applying a silane to a surface of the tape prior to bonding the glass or applying a tape comprising an acrylic pressure-sensitive adhesive polymer and a silane.

### BACKGROUND

The present invention relates to bonding glass using an adhesive. Conventionally, glazing panels (whether for architectural or vehicular use) may be bonded to supporting frames by means of bonding material interposed between the frame and the glazing panel. The bonding material is typically applied as a bead around the periphery of the panel or frame in relatively softened condition or uncured liquid form; subsequently, the bonding material cures (hardens) to hold the glazing panel securely bonded in the frame. Polyurethane and silicone adhesive and sealant materials are frequently used for the bonding material.

Glass has a relatively hydrophilic surface, which makes bonding a glass surface to an adhesive difficult. Additionally, water generally undercuts adhesive bonds to glass. In order to prevent such undercutting and improve adhesion, glass generally is primed or treated with a silane solution on the glass surface. Some silane solutions used to prime glass surfaces contain a silane coupling agent that chemically reacts with the glass surface and also improves the bond between the glass surface and the adhesive.

A known method for bonding a glass surface is to: 1) apply a single application of a silane solution, typically a solution of silane, isopropanol and water, to the glass surface, 2) leave the silane solution on the glass surface, 3) gently wipe the treated surface dry with a clean, lint-free cloth or tissue, and 4) then apply a pressure-sensitive adhesive to the treated surface within 15 minutes of application of the silane solution.

Self-cleaning and easy-cleaning glass technologies are being introduced into the residential and commercial window market. These technologies utilize hydrophilic coatings of titania (titanium dioxide) and silica. In addition to improving the hydrophilic nature of the glass, the titanium dioxide functions as a photocatalyst to degrade any dirt that contacts the glass.

These coated glass surfaces are even more difficult to adhesively bond due to their increased hydrophilic surface. However, it has been observed that typical silane primer solutions in contact with these surfaces destroy the self-cleaning or easy clean feature.

Thus, any silane primer that is used with such coated windows must be selectively applied only to the surface of the coated glass to be bonded by the adhesive through masking or precision guided application equipment. Such application techniques are typically time consuming and expensive.

### SUMMARY

In one embodiment, the invention provides a method for bonding glass comprising the steps of providing a tape comprising an acrylic pressure-sensitive adhesive polymer; applying a silane to a surface of the tape to form a bonding surface; and contacting the bonding surface of the tape with the glass to form a bonded glass, wherein the tape is the primary bonding means. In one aspect, the silane solution is wet upon contact with the glass. In another aspect, the silane solution is dry upon contact with the glass.

In another embodiment, the invention provides a method of bonding glass comprising the steps of providing a tape comprising a mixture of an acrylic pressure-sensitive adhesive polymer and a silane; and contacting a bonding surface of the tape with glass to form a bonded glass, wherein the tape is the primary bonding means.

In another embodiment, the invention provides a method of bonding glass comprising the steps of providing a tape comprising an acrylic pressure-sensitive adhesive polymer; providing a glass substrate; applying a silane to a surface of the glass to form a wet bonding surface; and contacting the wet bonding surface with the tape to form a bonded glass, wherein the tape is the primary bonding means.

### DETAILED DESCRIPTION

As used in this application, “adhesive” means an adhesive having a surface available for bonding that is either tacky at room temperature (i.e., pressure-sensitive adhesive) or becomes tacky when heated (i.e., heat-activated adhesive).

As used herein, “tape” means an adhesive article whose length is typically much greater than its width.

As used herein, “primary bonding means” means the principle or major means of bonding.

As used herein, “permanent bond” means the tape has a 90 Degree Peel Adhesion of at least about 20 pounds per inch width (3.52 kN/m) or exhibits cohesive failure when tested at room temperature on a glass substrate according to the 90 Degree Peel Adhesion Test Method described herein.

As used herein, “moisture stable bond” means the tape has a 90 Degree Peel Adhesion of at least about 20 pounds per inch width (3.52 kN/m) or exhibits cohesive failure after being aged at least 7 days at 38° C. (100° F.)/100% relative humidity and tested at room temperature on a glass substrate according to the 90 Degree Peel Adhesion Test Method described herein.

In one embodiment, useful acrylic tapes of the invention comprise an acrylic polymer. In some embodiments, the adhesive tape of the invention comprises an acrylic polymer of acrylic acid ester of nontertiary alcohol, the molecules of which have from 1-18 carbon atoms, at least a major proportion of said molecules having a carbon-to-carbon chain of 4-12 carbon atoms terminating at the hydroxyl oxygen atom, said chain containing at least about one-half the total number of carbon atoms in the molecule, said acrylic acid ester being per se polymerizable to a sticky, stretchable elastic adhesive polymer mass. Examples of suitable acrylic acid esters of nontertiary alcohols include but are not limited to 2-methylbutyl acrylate, isooctyl acrylate, lauryl acrylate, 4-methyl-2-pentyl acrylate, isoamyl acrylate, sec-butyl acrylate, n-butyl acrylate, n-hexyl acrylate, 2-ethylhexyl acrylate, n-octyl acrylate, n-decyl acrylate, isodecyl acrylate, isodecyl methacrylate, and isononyl acrylate. Particularly suitable acrylic acid esters of nontertiary alcohols are 2-ethylhexyl acrylate and isooctylacrylate.

In order to enhance the internal strength of the adhesive matrix, the acrylic polymer may be a copolymer of said acrylic acid ester and one or more copolymerizable monoethylenically unsaturated monomers which have highly polar groups such as are present in acrylic acid, methacrylic acid, itaconic acid, acrylamide, methacrylamide, N-substituted acrylamides (e.g., N,N-dimethyl acrylamide), acrylonitrile, methacrylonitrile, hydroxyalkyl acrylates, cyanoethyl acrylate, N-vinylpyrrolidone, N-vinylcaprolactam, and maleic anhydride. Generally, such copolymerizable monomers should be used in amounts less than 20% by weight of the adhesive matrix so that the adhesive is tacky at ordinary room temperatures, except that such tackiness can be preserved at up to 50% by weight of N-vinylpyrrolidone. Larger amounts of such copolymerizable monomers would require the novel tape to be heated to make its adhesive matrix tacky and pressure-sensitive. Particularly useful are acrylate copolymers comprising at least about 6% by weight acrylic acid, and in other embodiments, at least about 8% by weight, and at least about 10% by weight acrylic acid based on the total weight of the monomers in the acrylate copolymer.

The adhesive may also include small amounts of other useful copolymerizable monoethylenically unsaturated monomers such as alkyl vinyl ethers, vinylidene chloride, styrene, and vinyltoluene. To further enhance the cohesive strength of the adhesive, it may be made with a crosslinking agent such as 1,6-hexanediol diacrylate, with a photoactive triazine crosslinking agent such as taught in U.S. Pat. Nos. 4,330,590 and 4,329,384, or with a heat-activatable crosslinking agent such as a lower-alkoxylated amino formaldehyde condensate having C ₁₋₄ alkyl groups, for example, hexamethoxymethyl melamine or tetramethoxymethyl urea or tetrabutoxymethyl urea. Crosslinking can also be affected by irradiating the adhesive with electron beam (Ebeam) radiation, gamma radiation, x-ray radiation, and the like. Bisamide crosslinkers may be used with acrylic adhesives that are in a solution.

The adhesive used in the tape of the invention can be prepared by any suitable polymerization method. Suitable polymerization methods include but are not limited to photopolymerization, thermal polymerization, or ionizing radiation polymerization. These methods can be carried out in solution, emulsion, or bulk without solvent. Bulk polymerization methods are described in U.S. Pat. No. 5,804,610, incorporated by reference herein.

In making the tapes by photopolymerization as taught in U.S. Pat. No. 4,303,485, the photopolymerizable monomers may be partially polymerized to a coatable viscosity within the range of about 1000 to 40,000 cps. Alternatively, partial polymerization can be effected by heat. Viscosities within the range of 5,000 to 15,000 cps are preferred for ease of handling. Instead of being partially polymerized, the monomers can be mixed with a thixotropic agent such as fumed silica, followed by the coating and photopolymerizing steps.

Photopolymerization preferably is carried out in an inert atmosphere such as nitrogen. Instead, an inert atmosphere can be achieved by temporarily covering the photopolymerizable coating with a plastic film that is transparent to ultraviolet radiation, and irradiating through that film in air. If the polymerizable coating is not covered during photopolymerization, the permissible oxygen content of the inert atmosphere can be increased by mixing into the photopolymerizable composition an oxidizable tin compound as taught in U.S. Pat. No. 4,303,485, which also teaches that by doing so, thick coatings can be polymerized in air.

The weight average molecular weight of adhesive polymer before crosslinking is typically at least about 600,000 (e.g., at least about 800,000 and at least about 1,000,000). Polymers having a high molecular weight and a low crosslink density typically have better adhesion properties and stress distribution properties than polymers having low molecular weight or high crosslink density.

Normal additives, such as fillers, antioxidants, viscosity modifiers, pigments, tackifying resins, fibers, flame retardants, antistatic and slip agents, thermally conductive particles, electrically conductive particles, continuous microfibers, filaments, and the like can also be added to the adhesive polymer, to the extent that they do not alter the desired properties of the final product.

The acrylic adhesive matrix may be coated onto and polymerized against a flexible backing sheet (e.g., a release liner) that has a low-adhesion surface from which the polymerized layer is readily removable and almost always is self-sustaining. If the opposite face of the backing sheet also has a low-adhesion surface, the backing sheet with its polymerized layer may be wound up in roll form for convenient storage and shipment.

In some embodiments, the adhesive tape is an acrylic, self-adhering foam (i.e., self-stick foam). The foam may be an open cell foam, a closed cell foam, or a combination thereof. The foams may contain additives such as tackifiers, plasticizers, pigments, dyes, foam stabilizers, surfactants, reinforcing agents, hydrophobic or hydrophilic metal oxides, calcium carbonate, toughening agents, thermally conductive particles, electrically conductive particles, fire retardants, antioxidants, finely ground polymeric particles, stabilizers, continuous microfibers, and combinations thereof.

In one foam embodiment, the adhesive comprising an acrylic pressure-sensitive adhesive polymer further contains microbubbles, for example, glass microbubbles. Useful glass microbubbles include those having a density of less than 0.4 g/cm and having a diameter of from about 5 to about 200 micrometers. The glass microbubbles may be clear, coated, stained, or a combination thereof. The glass bubbles typically comprise from about 5 to about 65 volume percent of the acrylic tape. Examples of useful acrylic foams are disclosed in U.S. Pat. Nos. 4,415,615 and 6,103,152.

In some embodiments, foams may be formed by blending expanded microspheres into a composition. In some embodiments, foams may be formed by blending expandable microspheres into a composition and expanding the microspheres.

An expandable polymeric microsphere comprises a polymer shell and a core material in the form of a gas, liquid, or combination thereof. Upon heating to a temperature at or below the melt or flow temperature of the polymeric shell, the polymer shell will expand. Examples of suitable core materials include propane, butane, pentane, isobutane, neopentane, isopentane or a similar material, and combinations thereof. The identity of the thermoplastic resin used for the polymer microsphere shell can influence the mechanical properties of the foam, and the properties of the foam may be adjusted by the choice of microsphere, or by using mixtures of different types of microspheres.

Examples of commercially available expandable microspheres include those available under the trade designations F30D, F80SD, and F100 from Pierce Stevens, located in Buffalo, N.Y., and Expancel™ 551, Expancel™ 461, and Expancel™ 091, from Expancel, Inc., located in Duluth, Georgia.

Methods of making the above foams containing expandable polymeric microspheres and a description of such useful microspheres are described in U.S. Pat. No. 6,103,152, incorporated by reference herein.

Foams may also be prepared by forming gas voids in a composition using a variety of mechanisms including, e.g., mechanical mechanisms, chemical mechanisms, and combinations thereof.

Useful mechanical foaming mechanisms include, e.g., agitating (e.g., shaking, stirring, or whipping the composition, and combinations thereof), injecting gas into the composition (e.g., inserting a nozzle beneath the surface of the composition and blowing gas into the composition), and combinations thereof. Particular methods of making the above foams containing voids formed via a gas are described in U.S. Pat. No. 6,586,483, incorporated by reference herein.

In some embodiments, the adhesive tape is a composite tape where an acrylic pressure-sensitive adhesive layer comprising an acrylic pressure-sensitive adhesive polymer is provided on at least a portion of a core layer. Such tapes may be single sided tapes or double sided tapes. The core layer can be, for example, a foam (e.g., an acrylic foam such as those described above, a polyolefin foam (e.g., polyethylene, polypropylene, ethylene vinyl acetate copolymer, ethylene acrylic acid copolymer, ionomer of ethylene and mixtures thereof), a polyurethane foam, a rubber foam, or a silicone foam); a metal film or foil (e.g. aluminum film or foil); a polymeric scrim; a metal scrim; a mesh; a polymeric film; a woven material (e.g., fabric); or a nonwoven material. Acrylic foams are useful due to their ultraviolet light stability, conformability, and ability to distribute stress. In embodiments of the invention, acrylic foams have a foam density of about 20 pounds/cubic foot (20 lbs/ft³) (320 kg/m³) to about 50 lbs/ft³ (801 kg/m³) (e.g., from about 25 lbs/ft³ (400 kg/m³) to about 45 lbs/ft³ (721 kg/m³), from about 25 lbs/ft³ (400 kg/m³) to 40 lbs/ft³ (641 kg/m³)).

Polymers useful for the acrylic pressure-sensitive adhesive layer includes acrylate and methacrylate polymers and copolymers. Such polymers are formed, for example, by polymerizing one or more monomeric acrylic or methacrylic esters of non-tertiary alkyl alcohols, with the alkyl groups having from 1 to about 20 carbon atoms (e.g., from 3 to 18 carbon atoms). Suitable acrylate monomers include, for example, methyl acrylate, ethyl acrylate, n-butyl acrylate, lauryl acrylate, 2-ethylhexyl acrylate, cyclohexyl acrylate, iso-octyl acrylate, octadecyl acrylate, nonyl acrylate, decyl acrylate, and dodecyl acrylate. The corresponding methacrylates are useful as well. Also useful are aromatic acrylates and methacrylates, e.g., benzyl acrylate and cyclobenzyl acrylate.

Optionally, one or more monoethylenically unsaturated co-monomers may be polymerized with the acrylate or methacrylate monomers. The particular type and amount of co-monomer is selected based upon the desired properties of the polymer. One group of useful co-monomers includes those having a homopolymer glass transition temperature greater than the glass transition temperature of the (meth)acrylate (i.e., acrylate or methacrylate) homopolymer. Examples of suitable co-monomers falling within this group include acrylic acid, acrylamides, methacrylamides, substituted acrylamides (such as N,N-dimethyl acrylamide), itaconic acid, methacrylic acid, acrylonitrile, methacrylonitrile, vinyl acetate, N-vinyl pyrrolidone, isobornyl acrylate, cyano ethyl acrylate, N-vinylcaprolactam, maleic anhydride, hydroxyalkyl(meth)-acrylates, N,N-dimethyl aminoethyl (meth)acrylate, N,N-diethylacrylamide, beta-carboxyethyl acrylate, vinyl esters of neodecanoic, neononanoic, neopentanoic, 2-ethylhexanoic, or propionic acids (e.g., those available from Union Carbide Corp. of Danbury, Conn., under the designation VYNATES) vinylidene chloride, styrene, vinyl toluene, and alkyl vinyl ethers.

A second group of monoethylenically unsaturated co-monomers that may be polymerized with the acrylate or methacrylate monomers includes those having a homopolymer glass transition temperature (Tg) less than the glass transition temperature of the acrylate homopolymer. Examples of suitable co-monomers falling within this class include ethyloxyethoxyethyl acrylate (Tg=−71° C.) and a methoxypolyethylene glycol 400 acrylate (Tg=−65° C.; available from Shin Nakamura Chemical Co., Ltd. Japan, under the designation NK Ester AM-90G).

Blends of acrylic pressure-sensitive adhesive polymers and rubber based adhesives in particular, elastomeric block copolymer-based adhesives (e.g., tackified SIS or SBS based block copolymer adhesives), may also be used as an acrylic pressure-sensitive adhesive layer such as is described in PCT International Publication No. WO 01/57152, which is incorporated in its entirety herein by reference thereto.

As mentioned above, the adhesive tape may comprise a second adhesive layer located on the surface opposite the adhesive layer comprising an acrylic pressure-sensitive adhesive polymer. A variety of different polymer resins, as well as blends thereof, are suitable for use in the second adhesive layer. In some embodiments, the second adhesive layer may be a pressure-sensitive adhesive (PSA). In some embodiments, it may be desirable to blend two or more acrylate polymers having different chemical compositions. A wide range of physical properties can be obtained by manipulation of the type and concentration of the blend components. Selection of the second adhesive will depend on the substrate to which it will be adhered.

Useful polymers for the second adhesive layer include acrylate polymers as described above for the acrylic pressure-sensitive adhesive layer, semicrystalline polymer resins, such as polyolefins and polyolefin copolymers (e.g., polymer resins based upon monomers having between about 2 and about 8 carbon atoms, such as low-density polyethylene, high-density polyethylene, polypropylene, ethylene-propylene copolymers, etc.), polyesters and co-polyesters, polyamides and co-polyamides, fluorinated homopolymers and copolymers, polyalkylene oxides (e.g., polyethylene oxide and polypropylene oxide), polyvinyl alcohol, ionomers (e.g., ethylene-methacrylic acid copolymers neutralized with a base), and cellulose acetate. Other examples of polymers in this class include amorphous polymers such as polyacrylonitrile, polyvinyl chloride, thermoplastic polyurethanes, aromatic epoxies, polycarbonates, amorphous polyesters, amorphous polyamides, acrylonitrile-butadiene-styrene (ABS) block copolymers, polyphenylene oxide alloys, ionomers (e.g., ethylene-methacrylic acid copolymers neutralized with salt), fluorinated elastomers, and polydimethyl siloxane, elastomers containing ultraviolet radiation-activatable groups. Examples include polybutadiene, polyisoprene, polychloroprene, elastomeric random and block copolymers of styrene and dienes (e.g., SIS, SBS, SEBS, and SBR), and ethylene-propylene-diene monomer rubber. This class of polymer is typically combined with tackifying resins.

Another class of polymers useful in the second adhesive layer includes pressure-sensitive and hot melt applied adhesives prepared from non-photopolymerizable monomers. Such polymers can be adhesive polymers (i.e., polymers that are inherently adhesive), or polymers that are not inherently adhesive, but are capable of forming adhesive compositions when compounded with components such as plasticizers or tackifiers. Specific examples include poly-alpha-olefins (e.g., polyoctene, polyhexene, and atactic polypropylene), block copolymers, natural and synthetic rubbers, silicones, and ethylene-vinyl acetate.

In some embodiments, it may be desirable to use a silicone pressure-sensitive adhesive as a second adhesive layer. Useful silicone pressure-sensitive adhesive materials include those described in Handbook of Pressure Sensitive Adhesive Technology, 2^{nd} Ed., 1989, Chapter 18, pages 508-517, incorporated herein by reference. Silicone adhesives are, in general terms, blends of (i) polydiorganosiloxanes (also referred to as silicone gums typically having a number average molecular weight of about 5000 to about 10,000,000, preferably about 50,000 to about 1,000,000) with (ii) copolymeric silicone resins (also referred to as MQ resins typically having a number average molecular weight of about 100 to about 1,000,000, preferably about 500 to about 50,000) comprising triorganosiloxy units and SiO_{4/2} units. Preferably, silicone adhesives comprise from about 20 to about 60 parts by weight silicone gum and, correspondingly, from about 40 parts to about 80 parts by weight of an MQ resin. It is beneficial, in terms of improving adhesive properties, to provide a chemical means of reacting the copolymeric silicone resin with the polydiorganosiloxane. To achieve such a reaction, both condensation chemistry and addition-cure chemistry have been used.

In some embodiments, it may be desirable to use a silicone pressure-sensitive adhesive as a second adhesive layer, wherein the adhesive comprises a polydiorganosiloxane polyurea copolymer and a silicone tackifying resin with little or no silanol (Si—OH) functionality, such as those described in U.S. Patent Publication No. 2003-0152768-A1, incorporated herein by reference.

In other embodiments, it may be desirable that the second adhesive layer has good adhesion to low energy surfaces (e.g., polyolefins), such as those adhesives disclosed in U.S. Pat. No. 5,708,110, incorporated herein by reference. In some embodiments, the adhesive may be prepared by polymerizing a blend of monomers comprising less than about 5% (e.g., less than about 3%, or less than about 1%, or essentially 0%) by weight of polar ethylenically unsaturated monomers. Examples of such polar monomers include acrylic acid, itaconic acid, certain substituted acrylamides such as N,N-dimethyl acrylamide, N-vinyl-2-pyrrolidone, N-vinyl caprolactam, acrylonitrile, tetrahydrofurfuryl acrylate, glycidyl acrylate, 2-phenoxyethylacrylate, and benzylacrylate, or combinations thereof.

The first and/or second adhesive layer may also optionally have other components in it. Normal additives, such as fillers, antioxidants, viscosity modifiers, pigments, tackifying resins, fibers, flame retardants, antistatic and slip agents, thermally conductive particles, electrically conductive particles, continuous microfibers, scrims, webs, filaments, and the like can also be added to the adhesive layer, to the extent that they do not alter the desired properties of the final product.

The thickness of the adhesive layers varies depending on the use of the product. In some embodiments, the thickness of the adhesive layer is greater than about 250 micrometers (e.g., greater than about 500 micrometers). In other embodiments, the thickness may range from 25 micrometers to 100 micrometers.

A suitable composite tape comprises an acrylic foam core layer containing polymeric microspheres in combination and an acrylic/rubber-based blend adhesive layer. Another suitable multilayer tape comprises an acrylic foam core layer containing glass microbubbles and an acrylic adhesive layer.

The overall thickness of the adhesive tape, not including any release liners, is at least about 0.010 inches (0.025 cm), e.g., at least about 0.020 inches (0.051 cm), at least about 0.030 inches (0.076 cm), at least about 0.040 inches (0.102 cm). In other embodiments, the overall thickness of the tape, not including any release liners, is less than about 0.125 inches (0.317 cm). It is preferable that the tape has a static shear value of at least about 10,000 minutes under a load of 500 grams/square inch (6.45 cm²) at 70° C. and/or under a load of 1000 grams/square inch (6.45 cm²) at room temperature when measured on a stainless steel substrate according to ASTM D-3654.

In one embodiment, the method of the invention includes the step of applying a silane to a bonding surface of the acrylic tape. The silane functions as an adhesion promoter and/or coupling agent to improve adhesion of organic resins to inorganic surfaces. Silanes that possess both organic and inorganic reactivity that allow them to react with or “couple” to organic polymers and inorganic surfaces are useful, for example, those silanes having silanol groups. Silanes that possess reactive functionality such as a double bond may be incorporated into the backbone of an organic polymer during manufacture of the polymer. This offers several advantages such as reduced mobility of the silane and the ability for hot melt processing the silane-containing polymer.

Examples of such useful silanes include epoxy silane such as Dow Corning® Z-6040 Silane (3-glycidoxypropyltrimethoxysilane) available from Dow Coming Corporation, Midland, Mich.; vinyl silane such as Dow Corning® Z-6075 Silane (vinyltriacetoxy silane) available from Dow Corning Corporation; epoxy melamine silane such as Dow Corning® Z-6106 Silane (epoxysilane-modified melamine) available from Dow Coming Corporation; amino silane such as Dow Corning® Z-6011 Silane (aminopropyltriethoxy silane) available from Dow Coming Corporation; and methacrylate silane such as Dow Corning® Z-6030 Silane (3-methacryloxypropyltrimethoxy silane) available from Dow Coming Corporation, and combinations thereof.

The silane is generally provided as a solution prepared by adding silane to a mixture of a solvent, for example, isopropanol (iPA) and water, at room temperature. The weight ratio of the solvent/water can range from 50/50 to 99.5/0.5. The amount of water will affect the stability of the silane solution and also the dry time needed for the solvent/water to evaporate. Generally, the silane solution contains from about 0.1 to about 1% by weight silane based on total weight of the silane solution. In particular, the silane solution contains from about 0.3 to about 0.7% by weight of silane based on the total weight of the silane solution.

The type of glass that may be bonded is generally not limited. Typically, the glass comprises soda, lime, and silica. Window glass and plate glass have the same composition (soda-lime-silica), differing only in the method of manufacture. Heat resistant glass is a soda-lime glass containing approximately 5% boric acid. Such glass is known as borosilicate glass. The glass may also have a “self-cleaning” coating on its surface. Examples of self-cleaning coatings include titania (titanium dioxide). Such coatings are hydrophilic and provide a low water contact angle that results in water sheeting off the glass surface.

The bonded glass resulting from the methods of the invention may also be further bonded to other substrates to form an article or assembly such as a window. Typical substrates include window components, e.g., frames, sashes, muntin bars, and the like. Such substrates may be made from a variety of materials. Such materials include wood, composites of wood and polymers, composites of metals and other materials, materials having high silica or silicate content such as certain ceramics, and metals such as aluminum and alloys of aluminum. The wood, composites, and metals may be treated primed, coated, laminated, painted, and the like. For window applications, the tape is typically colored, e.g., white, black, or grey with grey being preferred. Additional articles or assemblies that are bonded to glass include, but are not limited to, automotive articles such as antenna and global positional systems, and construction assemblies such as solar panels. For window glazing and muntin bar attachment, it is preferred that the tape is a foam tape which compensates for irregularities in substrate surfaces and for expansion/contraction due to thermal effects. Particularly, for window glazing and muntin bar attachment, the thickness of the tape is at least about 0.010 inches (0.025 cm) (e.g., at least about 0.020 inches (0.051 cm), at least about 0.030 inches (0.076 cm), at least about 0.040 inches (0.102 cm)). Particularly, for window glazing and muntin bar attachment, the thickness of the tape is less than about 0.125 inches (0.317 cm).

In one embodiment, a method of bonding glass comprises applying a silane to one surface of the tape comprising an acrylic adhesive polymer and attaching the silane coated surface of the tape to the glass while the silane on the surface of the tape is still wet. This method allows the tape on the glass surface to be repositioned. Once into position, the tape can be pressed in place to expel excess silane solution and will form a moisture stable bond to the glass. The silane solution solvent, if present, is either evaporated away and/or adsorbed into the adhesive. Typically, but not required, the other side of the tape is bonded to a substrate before the tape is bonded to the glass. One advantage of allowing for movement or positioning of the tape on the glass is to provide accurate placement of the tape on the glass and for rapid bonding to take place.

In another embodiment, a method of bonding glass comprises the steps of applying a silane to one surface of the tape comprising an acrylic adhesive polymer, allowing the silane solvent, if present, to substantially evaporate or dry, and applying the silane coated surface of the tape to the glass surface.

In another embodiment, a method of bonding glass comprises the step of applying a tape comprising an acrylic adhesive polymer and silane incorporated therein to a glass surface.

In another embodiment, a method of bonding glass comprises the steps of applying a silane to a glass surface and attaching the tape to the glass surface while the silane on the glass surface is still wet.

When the silane is combined with the polymer, the silane may be present in an amount from about 0.25 to about 5.0% by weight based on the total weight of the polymer. Silane may be incorporated into the adhesive by using mixing means known in the art.

The methods of the invention provide precise placement of the silane onto the surface of the glass. These methods minimize the potential for damaging self-cleaning and easy-cleaning coated glass.

When applied in accordance with the above methods, the tape desirably develops a permanent bond to glass within 72 hours of application and/or exhibits cohesive failure.

When applied in accordance with the above methods, the tape preferably develops a moisture stable bond to glass (i.e., exhibits cohesive failure) after being aged 7 days at 38° C. (100° F.)/100% relative humidity and tested at room temperature on a glass substrate according to the 90 Degree Peel Adhesion Test Method described herein.

### EXAMPLES

In the test methods and examples below, the sample dimensions (typically the length) are approximate except for the width wherein the width was measured to the accuracy of the cutting tool.

### Test Methods

90 Degree Peel Adhesion Test Method

A 25.4 mm (one inch) wide (unless otherwise specified) by about 152 mm (6 inches) long sample was cut from the article to be tested and laminated to an about 165 mm (6.5 inches) long by about 28.6 mm (1.125 inches) wide by 0.127 mm (0.005 inches) thick anodized aluminum foil by rolling down the article onto the anodized side of the aluminum foil, taking care not to trap air bubbles between the foil and the tape.

The foil/tape laminate was bonded to a glass substrate (as specified in the Examples below) using one of the following conditions:
Condition A: The glass substrate was cleaned with a 50/50 isopropanol/water solution and wiped with clean tissue to dry. The foil/tape laminate was bonded to the cleaned dry glass surface.
Condition B: The glass substrate was sprayed with a silane solution and left on for at least 10 seconds. The foil/tape laminate was bonded to the silane treated, wet glass surface.
Condition C: The glass substrate was sprayed with a silane solution, left on for about 5 to 10 seconds, and wiped dry with clean tissue. The foil/tape laminate was bonded to the silane treated, dry glass surface within 15 minutes of application.
Condition D: The glass substrate was cleaned with isopropanol and wiped with clean tissue to dry. The tape surface of the foil/tape laminate was sprayed with a silane solution and bonded to the surface of the glass while the silane treated tape surface was still wet.
Condition E: The glass substrate was cleaned with a 50/50 isopropanol/water solution and wiped with clean tissue to dry. The tape surface of the foil/tape laminate was sprayed with a silane solution, the silane solution was allowed to dry in ambient conditions, and then the silane treated, dry tape surface was bonded to the surface of the glass.

In all conditions/instances, the laminate was placed on the glass with a portion of the laminate extending off the panel to serve as a tab. The laminate was rolled down onto the glass substrate using a 2 kg (4.5 lb) hard rubber roller, with two passes in each direction. Care was taken not to trap bubbles between the glass substrate and the laminate.

The sample thus prepared was allowed to dwell at room temperature (about 22° C.) for about 24 to 72 hours. Then the sample was aged at either room temperature (about 22° C.) or 38° C. (100° F.)/100% relative humidity for a specified time and then tested at room temperature for 90 Degree Peel Adhesion according to the Pressure Sensitive Tape Council Test Method PSTC-5 “Quick Stick of Pressure Sensitive Tapes”, except that the laminate was rolled down on the glass substrate, at crosshead speed of 30 cm/minute (12 inches/minute) using an INSTRON tensile tester. Typically, the peel value obtained from the first 12.5 mm (0.5 inch) length of peel was ignored. The peel value of the next 89 mm (3.5 inches) or “peel area” was recorded. The values reported were the integrated peel adhesion values and represent at least two replicates. Failure mode was also noted.

Materials

Certain commercially available materials were used in the Examples. These materials are listed below and are often referred to in the Examples with reference to their trade designations.

| Trade Designation | Description | Source |
|---|---|---|
| IRGACURE 651 | 2,2-dimethoxy-2- | Ciba Specialty Chemicals |
| | phenylacetophenone | Corp, Tarrytown, New York |
| IOA | Isooctyl acrylate monomer | 3M Company, St. Paul, |
| | | Minnesota |
| AA | Acrylic acid monomer | BASF, Mount Olive, New |
| | | Jersey |
| HDDA | 1,6-Hexanediol diacrylate | UCB Chemicals, Smyrna, |
| | monomer | Georgia |
| Z-6040 | 3-glycidoxypropyltrimethoxy | Dow Corning Corporation, |
| | silane | Midland, Michigan |
| A-187 | 3-glycidoxypropyltrimethoxy | Union Carbide Corp., |
| | silane | Danbury, Connecticut |
| Aerosil ™ R-972 | Hydrophobic fumed silica | Degussa Ridgefield Park, |
| | | New Jersey |
| Scotchlite ™ C-15/250 | Glass bubbles | 3M Company, St. Paul, |
| | | Minnesota |
| Miralite ™ 177 | Expanded polymeric | Pierce Stevens, Buffalo, New |
| | microspheres | Jersey |
| Gap-4 Silane Solution | Silane solution of 65-70% by | Custom-Pak Products, Inc., |
| | wt. isopropanol, 25-30% by wt. | Germantown, Wisconsin |
| | water, and <1% by wt. 3- | |
| | glycidoxypropyl trimethoxy | |
| | silane in pump mister | |
| Gap-11 Silane Solution | 75-80% by wt. isopropanol, <1% | Custom-Pak Products, Inc., |
| | by wt. 3-glycidoxypropyl | Germantown, Wisconsin |
| | trimethoxy silane, 15-20% by | |
| | wt. propane and 8-10% by wt. | |
| | n-butane in an aerosol can | |
| 3M ™ VHB ™ Acrylic Foam | 45.0 mil, thick conformable | 3M Company, St. Paul, |
| Tape 5952 | black acrylic foam carrier with | Minnesota |
| | a low surface energy synthetic | |
| | adhesive containing an acrylic | |
| | polymer, 0.5 inch or 1 inch | |
| | wide | |
| 3M ™ VHB ™ Acrylic Foam | 45.0 mil, thick closed cell dark | 3M Company, St. Paul, |
| Tape 4941 | gray acrylic foam carrier with | Minnesota |
| | an acrylic adhesive, 1 inch wide | |
| LoE²Plus ™ Insulated Glass | Insulated glass | Cardinal Glass Industries, |
| | | Eden Prairie, Minnesota |

### Example 1

A 0.5 inch (1.25 cm) wide 3M™ VHB™ Acrylic Foam Tape 5952 was applied to the perimeter inset ledge on all four sides of a pine wood window sash sealed with a protective finish (Minwax® Polycrylic® Protective Finish, Clear Gloss, Minwax® Company Inc., Montvale, New Jersey, applied according to manufacturer's instructions). The strips were placed so that there was no gap between the abutting ends. Hand pressure was used to press the tape against the sash surface. Approximately one inch (2.54 cm) of the perimeter of an insulated glass unit having a glass treatment thereon (LoE²Plus™) was wiped with a vinegar soaked tissue and dried with a clean dry tissue to remove the protective zinc oxide coating. The liner was removed from the tape, and Gap-11 Silane Solution was sprayed on the exposed surface of the tape. While the tape surface was still wet, the vinegar wiped area of insulate glass unit was joined to tape. Hand pressure was used to bond the glass to the tape and to carefully squeeze out the excess silane solution. The window trim pieces were then placed on the glass tight against the sash/frame.

The bonded window assembly was then visually examined for areas of non-contact immediately after bonding and after 24 hours. There were no bubbles, channels, or unbonded areas observed. The wet silane solution allowed the glass to be positioned without trapping any air while at the same time the solution functioned as a primer for the glass.

### Example 2

70% by weight isopropanol, 29.5% by weight water, and 0.5% by weight Z6040 silane were mixed together in a container to provide a silane solution (Solution A). One inch (2.54 cm) wide sample pieces/strips of 3M™ VHB™ Acrylic Foam Tape 4941 were bonded to standard glass under various conditions using the Solution A according to the procedure described in the 90 Degree Peel Adhesion Test Method and aged at 38° C. (100° F.)/100% relative humidity for 5 days. The bonded specimens were then tested for 90 Degree Peel Adhesion according to the test method described herein above.

Bonding conditions, peel adhesion values, and bond failure mode are given in Table 1 below.

TABLE 1

| | | Bonding | Peel Adhesion, lb/in | Failure |
|---|---|---|---|---|
| Sample No. | Rep. No. | Condition | (kN/m) | Mode |
| 2a | 1 | B | 24.3 (4.28) | FS |
| | 2 | B | 24.8 (4.36) | FS |
| 2b | 1 | D | 21.8 (3.84) | PFS |
| | 2 | D | 22.8 (4.01) | PFS |
| Comp. 1 | 1 | C | 31.9 (5.61) | FS |
| | 2 | C | 33.7 (5.93) | FS |

FS = foam split
PFS = partial foam split

Even after aging, the presence of foam split failure mode indicates that the 100% relative humidity condition did not deteriorate the bond between the adhesive tape and the glass.

### Example 3

One inch (2.54 cm) wide sample pieces/strips of 3M™ VHB™ Acrylic Foam Tape 5952 and 3M™ VHB™ Acrylic Foam Tape 4941 were bonded to standard glass under various conditions using Gap-4 Silane Solution and Gap-11 Silane Solution according to the procedure described in the 90 Degree Peel Adhesion Test Method. The bonded specimens were aged at room temperature and at 38° C. (100° F.)/100% relative humidity for 14 days. The bonded specimens were then tested for 90 Degree Peel Adhesion according to the test method described herein above.

Saline solution utilized, bonding conditions, peel adhesion values, and bond failure mode are given in Table 2 below. Samples 3a, 3b, and Comp. 2 were prepared using 3M™ VHB™ Acrylic Foam Tape 5952 and Samples 3c and Comp. 3 were prepared using 3M™ VHB™ Acrylic Foam Tape 4941.

TABLE 2

| | | | | Peel Adhesion | | | |
|---|---|---|---|---|---|---|---|
| | | | | | | 38° C. | |
| | | | | RT aged, | | (100° F.)/ | |
| Sample | Rep. | Silane | Bonding | lbs/in | Failure | 100% RH, | Failure |
| No. | No. | Solution | Condition | (kN/m) | Mode | lbs/in (kN/m) | Mode |
| 3a | 1 | Gap-11 | D | 21.0 | FS | 23.2 (4.08) | FS |
| | | | | (3.70) | | | |
| | 2 | Gap-11 | D | 20.0 | FS | 22.3 (3.92) | FS |
| | | | | (3.52) | | | |
| 3b | 1 | Gap-4 | D | NT | NT | 1.4 (0.246) | CP |
| | 2 | Gap-4 | D | NT | NT | 1.8 (0.317) | CP |
| Comp. 2 | 1 | Gap-11 | A | 26.1 | Foam | 11.7 (2.06) | FS/CP |
| | | | | (4.59) | Split | | |
| | 2 | Gap-11 | A | 26.8 | Foam | 26.2 (4.61) | FS/CP |
| | | | | (4.72) | Split | | |
| 3c | 1 | Gap-11 | D | 19.4 | FS | 18.4 (3.24) | FS |
| | | | | (3.41) | | | |
| | 2 | Gap-11 | D | 14.4 | FS/CP | 18.8 (3.31) | PFS |
| | | | | (2.53) | | | |
| Comp. 3 | 1 | Gap-11 | A | 29.8 | FS | 15.5 (2.73) | CP |
| | | | | (5.24) | | | |
| | 2 | Gap-11 | A | 30.5 | FS | 24.2 (4.26) | FS |
| | | | | (5.37) | | | |

FS = foam split
CP = clean peel
PFS = partial foam split
FS/CP = both foam split and clean peel
NT = not tested

Even after aging, the presence of foam split failure mode indicates that the 100% relative humidity condition did not deteriorate the bond between the adhesive tape and the glass. It is believed that the adhesion values and failure modes of Ex. 3b were due to the Gap-4 Silane Solution being near or at the end of its shelf life.

### Example 4

A mixture of 1456 grams of IOA, 144 grams of AA, and 0.64 grams of Irgacure™ 651 was partially photopolymerized in an inert (nitrogen) atmosphere using a bank of ultraviolet lamps to a viscosity of between 1000-5000 cps to provide a coatable syrup. To this syrup was then added 1.60 grams Irgacure™ 651 and 1.92 grams HDDA as a crosslinking agent. After mixing, 100 grams of the syrup was placed into jars. To each jar was added varying amounts by weight of A-187 silane based on 100 grams of the syrup (pph), 4 grams of Aerosil™ R-972, and 8 grams of Scotchlite™ C15/250 glass bubbles. After each addition, the mixture was shaken and/or stirred well to mix. After standing 12 hours at room temperature, each mixture was degassed under vacuum. Each mixture was then coated using a knife coater between two silicone coated, clear polyester liners (one 2 mil (0.0051 cm) thick with silicone on one side and the other 4 mils (0.010 cm) thick with silicone coated on both sides) and exposed on both top and bottom sides to banks of ultraviolet lamps for a total exposure energy of 417 millijoules total energy. The gap between the two liners was 29 mils (0.737 cm). The thickness of the foam tape obtained was about 31 mils (0.787 cm). A comparative sample was made as described above without silane.

The samples with liners attached were then exposed to either ambient temperature and humidity, or dry conditions in a dessicator for 1-12 months. After aging, the samples were bonded to standard glass using bonding Condition A according to the procedure described in the 90 Degree Peel Adhesion Test Method except that the samples were 0.5 inches (12.5 mm) wide instead of one inch (25.4 mm) wide. The bonded specimens were aged to 38° C. (100° F.)/100% relative humidity for 7 days. The bonded specimens were then tested for 90 Degree Peel Adhesion according to the test method described herein above.

The amount of silane utilized, exposure conditions, peel adhesion values, and bond failure mode are given in Table 3 below.

TABLE 3

| | Peel Adhesion, lbs/in (kN/m) and Failure Mode | | | |
|---|---|---|---|---|
| Exposure | | | 0.5 pph | 0.75 pph |
| Conditions | 0.0 pph A-187 | 0.25 pph A-187 | A-187 | A-187 |

Ambient temperature and humidity

| | | | | |
|---|---|---|---|---|
| 1 month | 7.2 (1.27) CP | 33.4 (5.88) FS | 28.2 (4.96) | 31.0 (5.45) |
| | | | FS | FS |
| 3 months | 10.4 (1.83) CP | 25.7 (4.52) FS | 15.8 (2.78) | 16.9 (2.97) |
| | | | PFS* | PFS* |
| 6 months | 10.6 (1.87) CP | 7.9 (1.39) CP | 9.0 (1.58) | 9.0 (1.58) |
| | | | CP | CP |
| 9 months | 13.7 (2.41) CP | 8.0 (1.41) CP | 8.4 (1.48) | 9.2 (1.62) |
| | | | CP | CP |

Dessicator

| | | | | |
|---|---|---|---|---|
| 1 month | 8.6 (1.51) CP | 33.1 (5.83) FS | 34.0 (5.98) | 31.7 (5.58) |
| | | | FS | FS |
| 3 months | 6.6 (1.16) CP | 31.3 (5.51) FS | 32.8 (5.77) | 30.5 (5.37) |
| | | | FS | FS |
| 6 months | 11.8 (2.08) CP | 29.4 (5.17) FS | 32.2 (5.67) | 28.2 (4.96) |
| | | | FS | FS |
| 9 months | 12.3 (2.16) CP | 33.1 (5.83) FS | 35.0 (6.16) | 31.1 (5.47) |
| | | | FS | FS |
| 12 months | 11.5 (2.02) CP | 15.0 (2.64) | 27.5 (4.84) | 20.2 (3.55) |
| | | PFS* | FS | PFS* |

*In many cases, light adhesive residue was evident on the glass.
FS = foam split
CP = clean peel
PFS = partial foam split

From the data it can be seen that long term storage of the tape in a dry environment greatly improves adhesion when compared to storage at ambient conditions.

### Example 5

A mixture of 91 grams of IOA, 9 grams of AA, and 0.04 grams of Irgacure™ 651 was partially photopolymerized in an inert (nitrogen) atmosphere using a bank of ultraviolet lamps to a viscosity of between 1000-5000 cps to provide a coatable syrup. To this syrup was then added 0.10 grams Irgacure™ 651 and 0.48 grams of a 25% by weight solution of HDDA in IOA as a crosslinking agent. After mixing, 0.5 grams A-187 silane, 4 grams of Aerosil™ R-972, and 8 grams of Scotchlite™ C15/250 glass bubbles were added. After each addition, the mixture was shaken and/or stirred well to mix. After standing 12 hours at room temperature, the mixture was degassed under vacuum, then coated using a knife coater between two silicone coated, clear polyester liners (one 2 mils (0.0051 cm) thick with silicone on one side and the other 4 mils (0.010 cm) thick with silicone coated on both sides) and exposed on both top and bottom sides to banks of ultraviolet lamps for a total exposure energy of 417 millijoules total energy. The gap between the two liners was 29 mils (0.737 cm). The thickness of the foam tape obtained was about 31 mils (0.787 cm).

The samples with liners attached were then exposed to either ambient temperature and humidity, 4.5-7.5° C. (40-45° F.) cold storage, or dry conditions in a dessicator for 1-12 months. After aging, the samples were bonded to standard glass using bonding Condition A according to the procedure described in the 90 Degree Peel Adhesion Test Method except that the samples were 0.5 inches (12.5 mm) wide instead of one inch (25.4 mm) wide. The bonded specimens were aged to 38° C. (100° F.)/100% relative humidity for 7 days. The bonded specimens were then tested for 90 Degree Peel Adhesion according to the test method described herein above.

The exposure conditions, peel adhesion values, and bond failure mode are given in Table 4 below.

TABLE 4

| | | |
|---|---|---|
| Exposure | Peel Adhesion, | |
| Conditions | lbs/in (kN/m) | Failure Mode |

Ambient temperature and humidity

| | | |
|---|---|---|
| 1 month | 29.8 (5.24) | FS |
| 3 months | 12.3 (2.16) | CP |

Cold Storage

| | | |
|---|---|---|
| 1 month | 34.1 (6.00) | FS |
| 3 months | 35.0 (6.16) | FS |
| 6 months | 34.1 (6.00) | FS |
| 9 months | 35.0 (6.16) | FS |
| 14 months | 26.2 (4.61) | FS |

Dessicator

| | | |
|---|---|---|
| 1 month | 34.7 (6.11) | FS |
| 3 months | 32.8 (5.77) | FS |
| 6 months | 36.1 (6.35) | FS |
| 9 months | 38.3 (6.74) | FS |
| 14 months | 25.9 (4.56) | PFS* |

*In many cases, light adhesive residue was evident on the glass.
FS = foam split
CP = clean peel
PFS = partial foam split

From the data, it can be seen that long term storage of the tape in a dry environment or cold environment greatly improves adhesion when compared to storage at ambient conditions.

### Example 6

Samples were prepared using the components and the procedure of Example 5 except that 2 grams of Miralite™177 expanded polymeric microspheres was used in place of 8 grams of Scotchlite™ C15/250 glass microspheres. A comparative sample was made as described above without silane.

The samples with liners attached were then exposed to either ambient temperature and humidity, 4.5-7.5° C. (40-45° F.) cold storage, or dry conditions in a dessicator for 1-12 months. After aging, the samples were bonded to standard glass using bonding Condition A according to the procedure described in the 90 Degree Peel Adhesion Test Method except that the samples were 0.5 inches (12.5 mm) wide instead of one inch (25.4 mm) wide. The bonded specimens were aged to 38° C. (100° F.)/100% relative humidity for 7 days. The bonded specimens were then tested for 90 Degree Peel Adhesion according to the test method described herein above.

The amount of silane utilized, exposure conditions, peel adhesion values, and bond failure mode are given in Table 5 below.

TABLE 5

| | | | | |
|---|---|---|---|---|
| | Peel Adhesion, | | Peel Adhesion, | |
| Exposure | lbs/in (kg/m) | Failure | lbs/in (kN/m) | Failure |
| Conditions | 0.0 pph A-187 | Mode | 0.5 pph A-187 | Mode |

Ambient temperature and humidity

| | | | | |
|---|---|---|---|---|
| 1 month | 3.9 (0.686) | CP | 29.0 (5.10) | FS |
| 3 months | 1.1 (0.194) | CP | 32.2 (5.67) | FS |
| 6 months | NT | NT | 31.9 (5.61) | FS |
| 9 months | NT | NT | 22.9 (4.03) | PFS* |
| 14 months | NT | NT | 9.9 (1.74) | CP |

Cold storage

| | | | | |
|---|---|---|---|---|
| 1 month | 4.8 (0.845) | CP | 31.8 (5.60) | FS |
| 3 months | 3.5 (0.616) | CP | 32.0 (5.63) | FS |
| 6 months | 2.0 (0.352) | CP | 31.8 (5.60) | FS |
| 9 months | NT | NT | 33.4 (5.88) | FS |
| 14 months | NT | NT | 32.9 (5.79) | FS |

Dessicator

| | | | | |
|---|---|---|---|---|
| 1 month | 5.6 (0.985) | CP | 28.5 (5.02) | FS |
| 3 months | 6.6 (1.16) | CP | 31.8 (5.60) | FS |
| 6 months | 3.2 (0.563) | CP | 32.2 (5.67) | FS |
| 9 months | NT | NT | 34.2 (6.02) | FS |
| 14 months | NT | NT | 32.9 (5.79) | FS |

*In many cases, light adhesive residue was evident on the glass.
FS = foam split
CP = clean peel
PFS = partial foam split
NT = not tested

From the data, it can be seen that long term storage of the tape in a dry environment or cold environment greatly improves adhesion when compared to storage at ambient conditions.

All patents, patent applications, and publications cited herein are each incorporated by reference, as if individually incorporated. Foreseeable modifications and alterations of this invention will be apparent to those skilled in the art without departing from the scope and spirit of this invention. This invention should not be restricted to the embodiments that are set forth in this application for illustrative purposes.

1. A method of bonding glass comprising the steps of:
providing a tape comprising an acrylic pressure-sensitive adhesive polymer;
applying a silane to a surface of the tape to form a bonding surface; and
contacting the bonding surface of the tape with glass to form a bonded glass, wherein the tape is the primary bonding means.

2. The method of claim 1 wherein the polymer has a weight average molecular weight of at least about 600,000.

3. The method of claim 1 wherein the tape is opaque and is colored black, white, or grey.

4. The method of claim 1 wherein the tape is a foam tape.

5. The method of claim 1 wherein the tape has a thickness of at least about 0.020 inches and less than about 0.125 inches.

6. The method of claim 1 wherein the tape is a composite tape comprising a core layer having a first side and a second side and an acrylic adhesive layer comprising an acrylic pressure-sensitive adhesive polymer on at least a portion of at least one side of said core layer.

7. The method of claim 1 wherein the core layer is selected from the group consisting of a foam, a metal film or foil, a polymeric scrim, a metal scrim, a mesh, a polymeric film, a woven material, and a nonwoven material.

8. The method of claim 7 wherein the core layer is an acrylic foam having a density of about 20 pounds/cubic foot to about 50 pounds/cubic foot.

9. The method of claim 7 wherein the core layer is an acrylic foam comprising glass microspheres, polymeric microspheres, or a combination thereof.

10. The method of claim 1 wherein the silane is wet when the bonding surface contacts the glass.

11. The method of claim 10 wherein the tape is movably positioned on the glass and then pressed in place.

12. The method of claim 1 wherein the silane is dried prior to contacting the bonding surface with the glass.

13. The method of claim 1 wherein the silane is provided in a solution of alcohol and water.

14. The method of claim 1 wherein the tape is bonded to a substrate before the step of applying a silane to a surface of the tape to form a bonding surface.

15. The method of claim 14 wherein the substrate is a window component other than a grooved sash.

16. The method of claim 1 wherein the tape further comprises elastomeric block copolymer-based adhesives.

17. The method of claim 7 wherein the core layer is selected from the group materials consisting of acrylic, polyolefin, polyurethane, rubber, silicone, or blends thereof.

18. The method of claim 1 further comprising the step of bonding the bonded glass to another substrate.

19. The method of claim 1 wherein the tape forms a permanent bond at room temperature.

20. The method of claim 1 wherein the tape forms a moisture stable bond at room temperature.

21. The method of claim 1 wherein the silane is selected from the group consisting of epoxy silane, vinyl silane, epoxysilane-modified melamine, amino silane, methacrylate silane, and combinations thereof.

22. The method of claim 1 wherein the silane comprises epoxy silane.

23. The method of claim 1 wherein the silane comprises 3-glycidoxypropyltrimethoxysilane.

24. The method of claim 1 wherein the glass has a hydrophilic coating.

25. The method of claim 24 wherein the coating comprises titania, silica, or a combination thereof.

26. A method of bonding glass comprising the steps of:
providing a tape comprising a mixture of an acrylic pressure-sensitive adhesive polymer and a silane; and
contacting a bonding surface of the tape with glass to form a bonded glass, wherein the tape is the primary bonding means.

27. The method of claim 26 wherein the acrylic pressure-sensitive adhesive polymer comprises 2-ethylhexyl acrylate or isooctyl acrylate or a combination thereof, and at least about 6% by weight of acrylic acid based on the total weight of monomers in the acrylate polymer.

28. The method of claim 26 wherein the silane comprises an epoxy silane.

29. A method of bonding glass comprising the steps of:
providing a tape comprising an acrylic pressure-sensitive adhesive polymer;
providing a glass substrate;
applying a silane to a surface of the glass to form a wet bonding surface; and
contacting the wet bonding surface with the tape to form a bonded glass, wherein the tape is the primary bonding means.

30. The method of claim 29 wherein the tape is a foam tape.

31. The method of claim 29 wherein the tape is a composite tape comprising a core layer having a first side and a second side and an acrylic adhesive layer comprising an acrylic pressure-sensitive adhesive polymer on at least a portion of at least one side of said core layer.

32. The method of claim 29 wherein the core layer is selected from the group consisting of a foam, a metal film or foil, a polymeric scrim, a metal scrim, a mesh, a polymeric film, a woven material, and a nonwoven material.

33. The method of claim 29 wherein the tape is bonded to a substrate before the step of applying the tape to the glass.

34. The method of claim 29 further comprising the step of bonding the bonded glass to another substrate.
